(19) United States
(12) Patent Application Publication
(10) Pub. No.: US 2019/0097244 A1
(43) Pub. Date: Mar. 28, 2019

(54) FUEL CELL METAL SEPARATOR AND POWER GENERATION CELL

(71) Applicant: HONDA MOTOR CO., LTD., Tokyo (JP)

(72) Inventors: Satoshi Oyama, Wako-shi (JP); Yu Tomana, Wako-shi (JP)

(21) Appl. No.: 16/139,118

(22) Filed: Sep. 24, 2018

(30) Foreign Application Priority Data
Sep. 25, 2017 (JP) 2017-183115

(51) Int. Cl. H01M 8/0258; H01M 8/0276

(52) U.S. Cl. CPC H01M 8/0258; H01M 8/0276

(57) ABSTRACT

In a first metal separator, first bead structure for preventing leakage of a reactant gas protrudes in a separator thickness direction. The first bead structure includes bead seals in two lines (a passage bead and an outer bead) between a separator outer end and a portion of an oxygen-containing gas supply passage adjacent to the separator outer end. One of the bead seals in two lines has a wavy shape, and the other of the bead seals has a straight shape, as viewed in the separator thickness direction.

### CROSS-REFERENCE TO RELATED APPLICATION

This application is based upon and claims the benefit of priority from Japanese Patent Application No. 2017-183115 filed on Sep. 25, 2017, the contents of which are incorporated herein by reference.

### BACKGROUND OF THE INVENTION

### Field of the Invention

The present invention relates to a fuel cell separator and a fuel cell stack.

### Description of the Related Art

In general, a solid polymer electrolyte fuel cell adopts a solid polymer electrolyte membrane. The solid polymer electrolyte membrane is a polymer ion exchange membrane. The fuel cell includes a membrane electrode assembly (MEA) formed by providing an anode on one surface of the solid polymer electrolyte membrane, and a cathode on the other surface of the solid polymer electrolyte membrane.

The membrane electrode assembly is sandwiched between separators (bipolar plates) to form a power generation cell (unit cell). In use, a predetermined number of power generation cells are stacked together to form, e.g. an in-vehicle fuel cell stack mounted in a vehicle.

In the power generation cell, as the separators, metal separators may be used. According to the disclosure of the specification of U.S. Pat. No. 7,718,293, in order to reduce the production cost, as seals, ridge shaped bead seals are formed by press forming in the metal separator.

### SUMMARY OF THE INVENTION

In the metal separators having the bead seals in two lines (dual bead seals), in particular, in the case where the bead seals in two lines extend in parallel in a portion between the reactant gas passage and the separator outer end, in this portion, the bead seals tend to be deformed easily, and the seal surface pressure tends to be decreased relatively, in comparison with the other portions. Therefore, the seal surface pressure tends to vary in the seal surface where the bead seals are provided.

The present invention has been made taking such problems into account, and an object of the present invention is to provide a fuel cell metal separator and a power generation cell in which it is possible to suppress variation of the seal surface pressure in bead seals.

In order to achieve the above object, the present invention provides a fuel cell metal separator including a reactant gas flow field for allowing a reactant gas to flow along an electrode surface, a reactant gas passage connected to the reactant gas flow field, and bead structure configured to prevent leakage of the reactant gas. The reactant gas passage extends through the fuel cell metal separator in a separator thickness direction. The bead structure protrudes in the separator thickness direction. The bead structure comprises bead seals in two lines between a separator outer end forming one side of the fuel cell metal separator and a portion of the reactant gas passage adjacent to the separator outer end, and one of the bead seals in two lines has a wavy shape, and another of the bead seals in two lines has a straight shape, as viewed in the separator thickness direction.

Preferably, the wavy bead seal may include at least one recess facing the straight bead seal, as viewed in the separator thickness direction.

Preferably, among the bead seals in two lines, the bead seal adjacent to the reactant gas passage may have a wavy shape.

Preferably, the wavy bead seal may be formed around the reactant gas passage, and the straight bead seal is formed around the reactant gas flow field, and extends between a plurality of the reactant gas passages.

Preferably, the reactant gas passage may be configured to have a shape where a side of the reactant gas passage adjacent to the separator outer end is shorter than a side of the reactant gas passage adjacent to the reactant gas supply flow field.

Further, the power generation cell of the present invention includes a membrane electrode assembly and the fuel cell separators including any of the above aspects provided on both sides of the membrane electrode assembly.

In the fuel cell metal separator and the power generation cell of the present invention, the bead seals in two lines are provided between the separator outer end and the portion of the reactant gas passage adjacent to the separator outer end. One of the bead seals has a wavy shape, and the other of the bead seals has a straight shape, as viewed in the separator thickness direction. Therefore, in comparison with the structure where both of the bead seals in two lines have a straight shape, improvement in the rigidity of the bead structure is achieved in the portion adjacent to the separator outer end. In the structure, since relative decrease in the seal surface pressure adjacent to the separator outer end is suppressed, it is possible to suppress variation in the seal surface pressure.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing a power generation cell according to an embodiment of the present invention;

FIG. 2 is a cross sectional view showing main components of a power generation cell taken along a line II-II in FIG. 1;

FIG. 3 is a plan view showing a first metal separator as viewed from an oxygen-containing gas flow field;

FIG. 4 is an enlarged view showing an area around an oxygen-containing gas supply passage of a first metal separator;

FIG. 5 is a cross sectional view taken along a line V-V in FIG. 4;

FIG. 6 is a plan view showing a second metal separator as viewed from a fuel gas flow field;

FIG. 7 is a graph showing the relationship between the load and the displacement amount in each of a straight bead seal and a wavy bead seal; and

FIG. 8 is an enlarged view showing an area around an oxygen-containing gas supply passage of a first metal separator according to a modified embodiment.

### DESCRIPTION OF THE PREFERRED EMBODIMENTS

Hereinafter a preferred embodiment of a fuel cell metal separator and a power generation cell according to the present invention will be described with reference to the accompanying drawings.

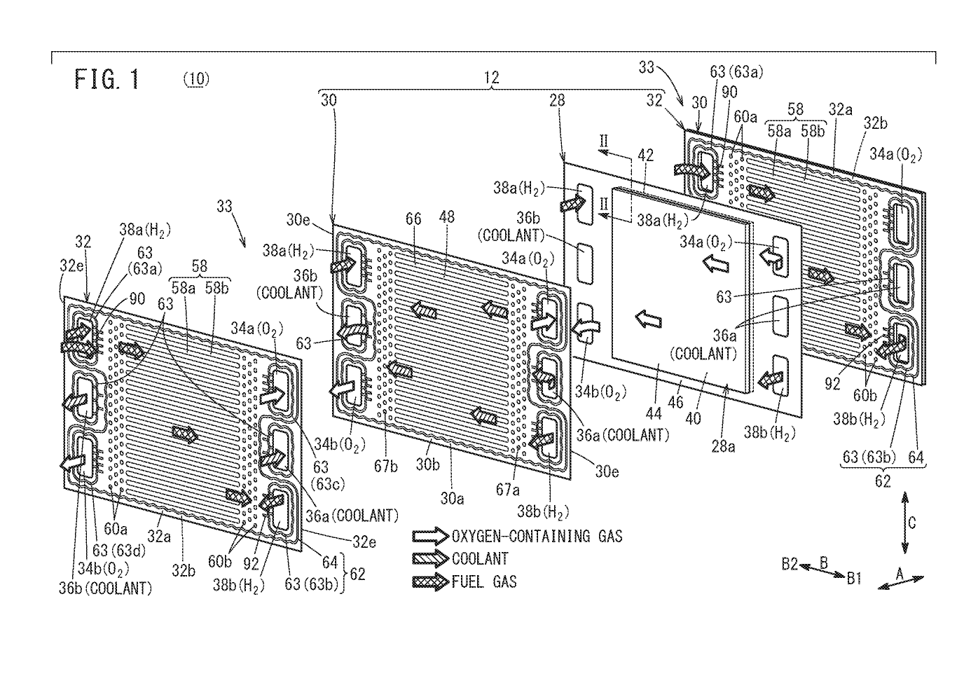

A power generation cell 12 as a part of a unit of a fuel cell (unit cell) shown in FIG. 1 includes a resin film equipped MEA 28, a first metal separator 30 provided on one surface of the resin film equipped MEA 28, and a second metal separator 32 provided on the other surface of the resin film equipped MEA 28. A plurality of power generation cells 12 are stacked together in a direction indicated by the arrow A (horizontal direction) or in a direction indicated by an arrow C (gravity direction), and a tightening load (compression load) is applied to the power generation cells 12 to form a fuel cell stack 10. For example, the fuel cell stack 10 is mounted as an in-vehicle fuel cell stack, in a fuel cell electric automobile (not shown).

Each of the first metal separator 30 and the second metal separator 32 is formed by press forming of a metal thin plate to have a corrugated shape in cross section. For example, the metal plate is a steel plate, a stainless steel plate, an aluminum plate, a plated steel plate, or a metal plate having an anti-corrosive surface by surface treatment. The first metal separator 30 of one of the adjacent power generation cells 12 and the second metal separator 32 of the other of the adjacent power generation cells 12 are joined together by welding, brazing, crimping, etc. to form a joint separator 33.

At one end of the power generation cell 12 in a longitudinal direction indicated by an arrow B1 (horizontal direction), an oxygen-containing gas supply passage 34a, a coolant supply passage 36a, and a fuel gas discharge passage 38b are provided. The oxygen-containing gas supply passage 34a, the coolant supply passage 36a, and the fuel gas discharge passage 38b extend through the power generation cell 12 in the stacking direction indicated by the arrow A. The oxygen-containing gas supply passage 34a, the coolant supply passage 36a, and the fuel gas discharge passage 38b are arranged in the vertical direction indicated by the arrow C. An oxygen-containing gas is supplied through the oxygen-containing gas supply passage 34a. A coolant such as water is supplied through the coolant supply passage 36a. A fuel gas such as a hydrogen-containing gas is discharged through the fuel gas discharge passage 38b.

At the other end of the power generation cell 12 in the longitudinal direction indicated by an arrow B2, a fuel gas supply passage 38a, a coolant discharge passage 36b, and an oxygen-containing gas discharge passage 34b are provided. The fuel gas supply passage 38a, the coolant discharge passage 36b, and the oxygen-containing gas discharge passage 34b extend through the power generation cell 12 in the stacking direction. The fuel gas supply passage 38a, the coolant discharge passage 36b, and the oxygen-containing gas discharge passage 34b are arranged in the vertical direction. The fuel gas is supplied through the fuel gas supply passage 38a. The coolant is discharged through the coolant discharge passage 36b. The oxygen-containing gas is discharged through the oxygen-containing gas discharge passage 34b. The layout of the oxygen-containing gas supply passage 34a, the oxygen-containing gas discharge passages 34b, the fuel gas supply passage 38a, and the fuel gas discharge passage 38b is not limited to the above embodiment, and may be changed depending on the required specification.

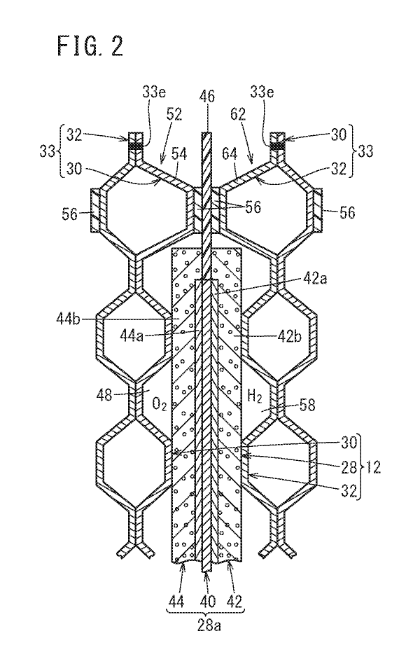

As shown in FIG. 2, the resin film equipped MEA 28 includes a membrane electrode assembly 28a, and a frame shaped resin film 46 provided in the outer portion of the membrane electrode assembly 28a. The membrane electrode assembly 28a includes an electrolyte membrane 40, and an anode 42 and a cathode 44 sandwiching the electrolyte membrane 40.

For example, the electrolyte membrane 40 includes a solid polymer electrolyte membrane (cation ion exchange membrane). For example, the solid polymer electrolyte membrane is a thin membrane of perfluorosulfonic acid containing water. The electrolyte membrane 40 is sandwiched between the anode 42 and the cathode 44. A fluorine based electrolyte may be used as the electrolyte membrane 40. Alternatively, an HC (hydrocarbon) based electrolyte may be used as the electrolyte membrane 40.

The cathode 44 includes a first electrode catalyst layer 44a joined to one surface of the electrolyte membrane 40, and a first gas diffusion layer 44b stacked on the first electrode catalyst layer 44a. The anode 42 includes a second electrode catalyst layer 42a stacked on the other surface of the electrolyte membrane 40, and a second gas diffusion layer 42b stacked on the second electrode catalyst layer 42a.

The inner end surface of the resin film 46 is positioned close to, overlapped with, or contacts the outer end surface of the electrolyte membrane 40. As shown in FIG. 1, at one end of the resin film 46 in the direction indicated by the arrow B1, the oxygen-containing gas supply passage 34a, the coolant supply passage 36a, and the fuel gas discharge passage 38b are provided. At the other end of the resin film 46 in the direction indicated by the arrow B2, the fuel gas supply passage 38a, the coolant discharge passage 36b, and the oxygen-containing gas discharge passage 34b are provided.

For example, the resin film 46 is made of PPS (poly phenylene sulfide), PPA (polyphthalamide), PEN (polyethylene naphthalate), PES (polyethersulfone), LCP (liquid crystal polymer), PVDF (polyvinylidene fluoride), a silicone resin, a fluororesin, m-PPE (modified poly phenylene ether), PET (polyethylene terephthalate), PBT (polybutylene terephthalate), or modified polyolefin. It should be noted that the electrolyte membrane 40 may be configured to protrude outward without using the resin film 46. Alternatively, a frame shaped film may be provided on both sides of the electrolyte membrane 40 which protrudes outward.

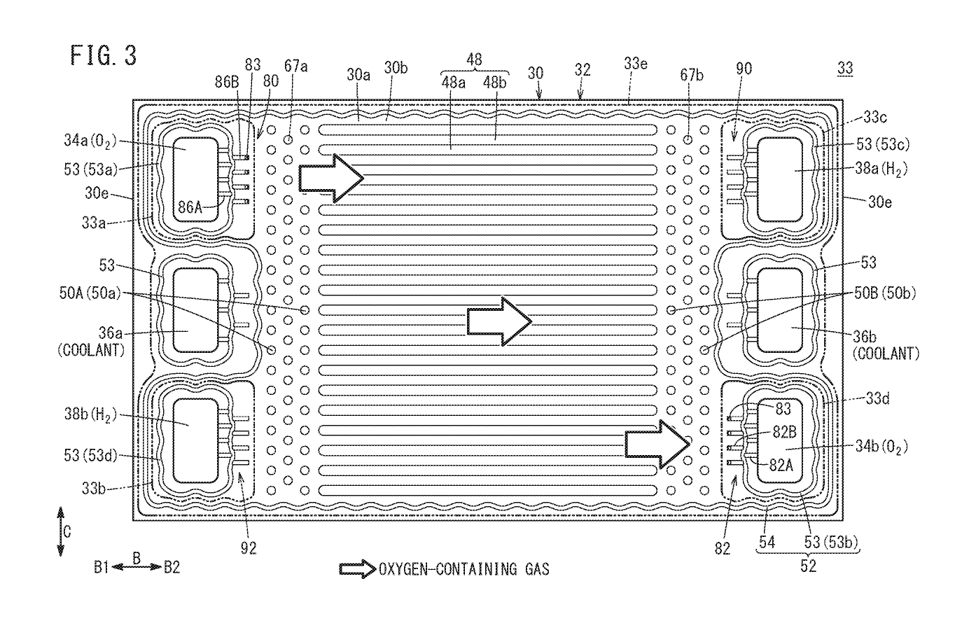

As shown in FIG. 3, an oxygen-containing gas flow field 48 is provided on a surface 30a of the first metal separator 30 facing the resin film equipped MEA 28 (hereinafter referred to as the “surface 30a”). For example, the oxygen-containing gas flow field 48 extends in the direction indicated by the arrow B.

The oxygen-containing gas flow field 48 is connected to (in fluid communication with) the oxygen-containing gas supply passage 34a and the oxygen-containing gas discharge passage 34b. The oxygen-containing gas flow field 48 includes straight flow grooves 48b between a plurality of ridges 48a extending in the direction indicated by the arrow B. Instead of the plurality of straight flow grooves 48b, a plurality of wavy or serpentine flow grooves may be provided.

An inlet buffer 50A is provided on the surface 30a of the first metal separator 30, between the oxygen-containing gas supply passage 34a and the oxygen-containing gas flow field 48. The inlet buffer 50A includes a plurality of boss arrays each including a plurality of bosses 50a arranged in a direction indicated by an arrow C. Further, an outlet buffer 50B is provided on the surface 30a of the first metal separator 30, between the oxygen-containing gas discharge passage 34b and the oxygen-containing gas flow field 48. The outlet buffer 50B includes a plurality of boss arrays each including a plurality of bosses 50b.

On a surface 30b of the first metal separator 30 on the other side of the oxygen-containing gas flow field 48, boss arrays each including a plurality of bosses 67a arranged in the direction indicated by the arrow C are provided between the boss arrays of the inlet buffer 50A, and boss arrays each including a plurality of bosses 67b arranged in the direction indicated by the arrow C are provided between the boss arrays of the outlet buffer 50B. The bosses 67a, 67b form a buffer on the coolant surface.

First bead structure 52 is formed on the surface 30a of the first metal separator 30 by press forming. The first bead structure 52 is expanded toward the resin film equipped

MEA 28 (FIG. 1). As shown in FIG. 2, resin material 56 is fixed to protruding front surfaces of the first bead structure 52 by printing, coating, etc. For example, polyester fiber is used as the resin material 56. The resin material 56 may be provided on the part of the resin film 46. The resin material 56 is not essential. The resin material 56 may be dispensed with.

As shown in FIG. 3, the first bead structure 52 includes a plurality of bead seals 53 (hereinafter referred to as the “passage beads 53”) provided around a plurality of fluid passages (oxygen-containing gas supply passage 34a, etc.), and a bead seal 54 (hereinafter referred to as the “outer bead 54”) provided around the oxygen-containing gas flow field 48, the inlet buffer 50A, and the outlet buffer 50B.

The plurality of passage beads 53 protrude from the surface 30a of the first metal separator 30 toward the resin film equipped MEA 28. The passage beads 53 are provided around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b, respectively.

Hereinafter, among the plurality of passage beads 53, the passage bead formed around the oxygen-containing gas supply passage 34a will be referred to as a “passage bead 53a”, and the passage bead formed around the oxygen-containing gas discharge passage 34b will be referred to as a “passage bead 53b”. Further, among the plurality of passage beads 53, the passage bead formed around the fuel gas supply passage 38a will be referred to as a “passage bead 53c”, and the passage bead formed around the fuel gas discharge passage 38b will be referred to as a “passage bead 53d”. The first metal separator 30 has bridge sections 80, 82 connecting the inside of the passage beads 53a, 53b (fluid passages 34a, 34b) and the outside (oxygen-containing gas flow field 48) of the passage beads 53a, 53b.

The bridge section 80 is provided on a side part of the passage bead 53a formed around the oxygen-containing gas supply passage 34a, adjacent to the oxygen-containing gas flow field 48. The bridge section 82 is provided on a side part of the passage bead 53b formed around the oxygen-containing gas discharge passage 34b, adjacent to the oxygen-containing gas flow field 48.

The passage bead 53a and the passage bead 53b have the same structure. Further, the bridge section 80 adjacent to the oxygen-containing gas supply passage 34a and the bridge section 82 adjacent to the oxygen-containing gas discharge passage 34b have the same structure. Therefore, hereinafter, the structure of the passage bead 53a and the bridge section 80 will be described in detail as a representative example, and the detailed description about the structure of the passage bead 53b and the bridge section 82 will be omitted.

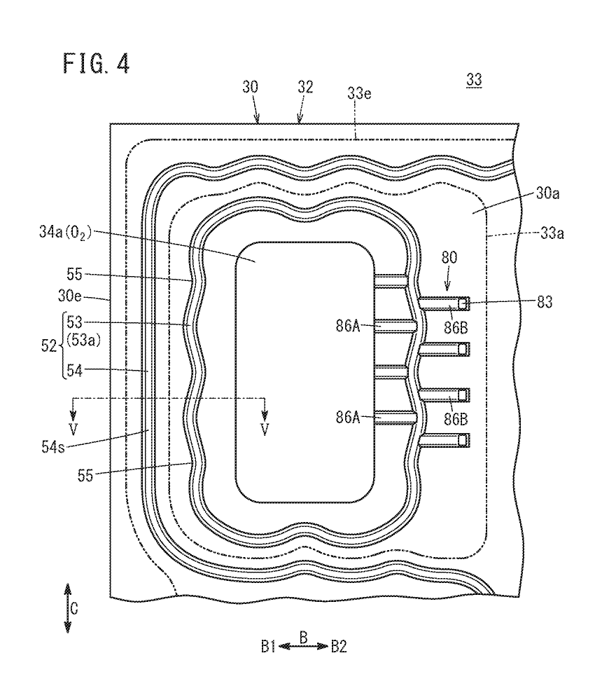

As shown in FIG. 4, the passage bead 53a has a wavy shape as viewed in the separator thickness direction. Specifically, the passage bead 53a has a wavy shape over the entire periphery of the oxygen-containing gas supply passage 34a as viewed in the separator thickness direction.

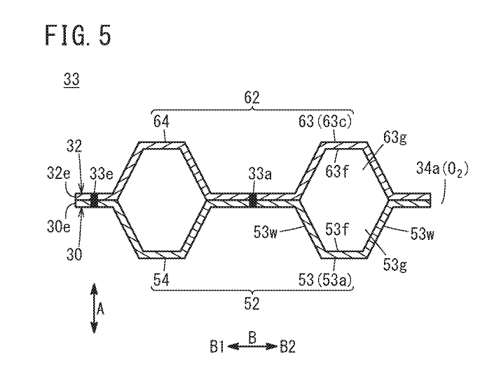

As shown in FIG. 5, the first separator 30 has a recess 53f on the back of the ridge shaped passage bead 53a. The recess 53f forms an internal space 53g of the passage bead 53a. The recess 53f of the first metal separator 30 faces a recess 63f (internal space 63g) on the back of a passage bead 63 described later, of the second metal separator 32.

In the embodiment of the present invention, side walls 53w of the passage bead 53 are inclined with respect to the separator thickness direction (stacking direction indicated by the arrow A). Therefore, the passage bead 53 has a trapezoidal shape in cross section taken along the separator thickness direction. When a tightening load is applied to the passage bead 53 in the stacking direction, the passage bead 53 is deformed elastically. The side walls 53w of the passage bead 53 may be in parallel to the separator thickness direction. That is, the passage bead 53 may have a rectangular shape in cross section taken along the separator thickness direction.

As shown in FIG. 4, the bridge section 80 includes a plurality of inner tunnels 86A provided at intervals inside the passage bead 53a, and a plurality of outer tunnels 86B provided at intervals outside the passage bead 53a. The inner tunnels 86A and the outer tunnels 86B are formed by press forming, to protrude from the surface 30a of the first metal separator 30 toward the resin film equipped MEA 28 (see FIG. 1).

The internal spaces formed by recesses on the back of the inner tunnels 86A are connected to the internal space 53g (FIG. 5) formed by a recess on the back of the passage bead 53a. An end of the inner tunnel 86A opposite to a portion of the inner tunnel 86A connected to the passage bead 53a is opened in the oxygen-containing gas supply passage 34a. The internal spaces of the outer tunnels 86B (formed by recesses on the back of the outer tunnels 86B) are connected to the internal space 53g of the passage bead 53a. A hole 83 is formed at an end of the outer tunnel 86B opposite to a portion of the outer tunnel 86B connected to the passage bead 53a.

In the embodiment of the present invention, the plurality of inner tunnels 86A and the plurality of outer tunnels 86B are provided alternately (in a zigzag pattern) along the passage bead 53a. The plurality of inner tunnels 86A and the plurality of outer tunnels 86B may be provided to face each other through the passage bead 53a.

As shown in FIG. 3, the outer bead 54 extends along opposite long sides of the first metal separator 30.

Further, at one end of the first metal separator 30 in the longitudinal direction (indicated by the arrow B1), the outer bead 54 is curved, and extends between the oxygen-containing gas supply passage 34a, the coolant supply passage 36a, and the fuel gas discharge passage 38b arranged along the short side of the first metal separator 30.

At the other end of the first metal separator 30 in the longitudinal direction (indicated by the arrow B2), the outer bead 54 is curved, and extends between the fuel gas supply passage 38a, the coolant discharge passage 36b, and the oxygen-containing gas discharge passage 34b arranged along the short side of the first metal separator 30. The passage beads 53a to 53d are provided in an area surrounded by the outer bead 54. The outer bead 54 is formed in a wavy shape, except straight portions described later, as viewed in the separator thickness direction.

As shown in FIG. 4, bead seals in two lines (dual beads) are formed by the passage bead 53a and the outer bead 54, between a separator outer end 30e (short side of the rectangular first metal separator 30 in FIG. 4) and the oxygen-containing gas supply passage 34a (portion of the oxygen-containing gas supply passage 34a adjacent to the separator outer end 30e). One of the bead seals in two lines has a wavy shape, and the other of the bead seals in two lines has a straight shape as viewed in the separator thickness direction. In the embodiment of the present invention, the passage bead 53a has a wavy shape, and the outer bead 54 has a straight shape, between the separator outer end 30e and the oxygen-containing gas supply passage 34a. That is, the outer bead 54 includes a straight portion 54s between the separator outer end 30e and the oxygen-containing gas supply passage 34a. The straight portion 54s extends in parallel with the separator outer end 30e as the short side of the first metal separator 30.

The wavy passage bead 53a has at least one recess 55 (a plurality of recesses 55 in the embodiment of the present invention) facing the straight portion 54s of the outer bead 54, between the separator outer end 30e and the oxygen-containing gas supply passage 34a, as viewed in the separator thickness direction. Instead of the at least one recess 55, at least one protrusion facing the straight portion 54s may be provided.

In contrast to the above structure, the passage bead 53a may be formed in a straight shape, and the outer bead 54 may be formed in a wavy shape between the separator outer end 30e and the oxygen-containing gas supply passage 34a.

As shown in FIG. 5, as in the case of the passage bead 53a, the outer bead 54 has a trapezoidal shape in cross section taken along the separator thickness direction. The outer bead 54 may have a rectangular shape in cross section taken along the separator thickness direction. Preferably, the passage bead 53 and the outer bead 54 have the same shape in cross section.

As shown in FIG. 3, as in the case of the structure around the oxygen-containing gas supply passage 34a, also in the structure around the oxygen-containing gas discharge passage 34b, the fuel gas supply passage 38a, and the fuel gas discharge passage 38b, bead seals in two lines, one of the bead seals has a wavy shape and the other of the bead seals has a straight shape, are formed by the passage bead 53 and the outer bead 54, between the separator outer end 30e and each of the fluid passages.

As shown in FIG. 1, the second metal separator 32 has a fuel gas flow field 58 on its surface 32a facing the resin film equipped MEA 28 (hereinafter referred to as the “surface 32a”). For example, the fuel gas flow field 58 extends in the direction indicated by the arrow B.

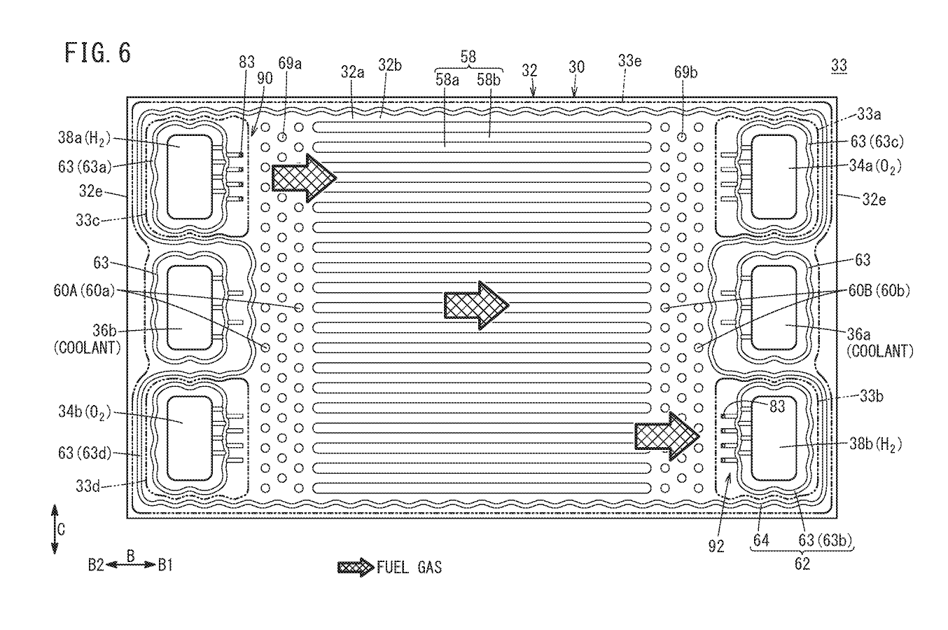

As shown in FIG. 6, the fuel gas flow field 58 is connected to (in fluid communication with) the fuel gas supply passage 38a and the fuel gas discharge passage 38b. The fuel gas flow field 58 includes straight flow grooves 58b between a plurality of ridges 58a extending in the direction indicated by the arrow B. Instead of the straight flow grooves 58b, wavy or serpentine flow grooves may be provided.

An inlet buffer 60A is provided on the surface 32a of the second metal separator 32, between the fuel gas supply passage 38a and the fuel gas flow field 58. The inlet buffer 60A includes a plurality of boss arrays each including a plurality of bosses 60a arranged in the direction indicated by the arrow C. Further, an outlet buffer 60B including a plurality of boss arrays is provided on the surface 32a of the second metal separator 32, between the fuel gas discharge passage 38b and the fuel gas flow field 58. Each of the boss arrays includes a plurality of bosses 60b.

On a surface 32b of the second metal separator 32 on the other side of the fuel gas flow field 58, boss arrays each including a plurality of bosses 69a arranged in the direction indicated by the arrow C are provided between the boss arrays of the inlet buffer 60A, and boss arrays each including a plurality of bosses 69b arranged in the direction indicated by the arrow C are provided between the boss arrays of the outlet buffer 60B. The bosses 69a, 69b form a buffer on the coolant surface.

Second bead structure 62 is formed on the surface 32a of the second metal separator 32. The second bead structure 62 is formed by press forming, and expanded toward the resin film equipped MEA 28.

As shown in FIG. 2, resin material 56 is fixed to protruding front surfaces of the second bead structure 62 by printing, coating, etc. For example, polyester fiber is used as the resin material 56. The resin material 56 may be provided on the part of the resin film 46. The resin material 56 is not essential. The resin material 56 may be dispensed with.

As shown in FIG. 6, the second bead structure 62 includes a plurality of bead seals 63 (hereinafter referred to as the “passage beads 63”) provided around the plurality of fluid passages (fluid passage 38a, etc.), respectively, and a bead seal 64 (hereinafter referred to as the “outer bead 64”) provided around the fuel gas flow field 58, the inlet buffer 60A and the outlet buffer 60B.

The plurality of bead seals 63 protrude from the surface 32a of the second metal separator 32, and are provided around the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b, respectively.

The second metal separator 32 has bridge sections 90, 92 connecting the inside of passage beads 63a, 63b (fluid passages 38a, 38b) around the fuel gas supply passage 38a and the fuel gas discharge passage 38b and the outside (fuel gas flow field 58) of the passage beads 63a, 63b.

The bridge section 90 is provided on a side part of the passage bead 63a formed around the fuel gas supply passage 38a, adjacent to the fuel gas flow field 58. The bridge section 92 (including some elements at intervals) is provided on a side part of the passage bead 63b formed around the fuel gas discharge passage 38b, adjacent to the fuel gas flow field 58.

The bridge sections 90, 92 provided in the second metal separator 32 and the bridge sections 80, 82 (FIG. 3) provided in the first metal separator 30 have the same structure. The passage beads 63a to 63d have the same structure and the layout as the above described passage beads 53a to 53d of the first metal separator 30 (FIG. 3). The outer bead 64 has the same structure as the above described outer bead 54 (FIG. 3) of the first metal separator 30. Therefore, the bead seals (passage bead 63 and outer bead 64) are formed in two lines between an outer end 32e of the second metal separator 32 and the portion of each fluid passage adjacent to the outer end 32e, and one of the bead seals has a wavy shape and the other of the bead seals has a straight shape, as viewed in the separator thickness direction.

As shown in FIG. 1, a coolant flow field 66 is formed between the surface 30b of the first metal separator 30 and the surface 32b of the second metal separator 32 that are joined together. The coolant flow field 66 is connected to (in fluid communication with) the coolant supply passage 36a and the coolant discharge passage 36b. The coolant flow field 66 is formed by stacking together a back surface of the first metal separator 30 (the shape on the back side of the oxygen-containing gas flow field 48) and a back surface of the second metal separator 32 (the shape on the back side of the fuel gas flow field 58).

As shown in FIG. 3, the first metal separator 30 and the second metal separator 32 of the joint separator 33 are joined together by laser welding lines 33a to 33e. The laser welding line 33a is formed around the oxygen-containing gas supply passage 34a and the bridge section 80. The laser welding line 33b is formed around the fuel gas discharge passage 38b and the bridge section 92. The laser welding line 33c is formed around the fuel gas supply passage 38a and the bridge section 90. The laser welding line 33d is formed around the oxygen-containing gas discharge passage 34b and the bridge section 82. The laser welding line 33e is formed around the oxygen-containing gas flow field 48, the fuel gas flow field 58, the coolant flow field 66, the oxygen-containing gas supply passage 34a, the oxygen-containing gas discharge passage 34b, the fuel gas supply passage 38a, the fuel gas discharge passage 38b, the coolant supply passage 36a, and the coolant discharge passage 36b, along the outer end of the joint separator 33. The first metal separator 30 and the second metal separator 32 may be joined together by brazing, instead of welding.

Operation of the power generation cell 12 having the above structure will be described below.

First, as shown in FIG. 1, an oxygen-containing gas such as air is supplied to the oxygen-containing gas supply passage 34a. A fuel gas such as a hydrogen-containing gas is supplied to the fuel gas supply passage 38a. Coolant such as pure water, ethylene glycol, oil is supplied to the coolant supply passage 36a.

The oxygen-containing gas flows from the oxygen-containing gas supply passage 34a to the oxygen-containing gas flow field 48 of the first metal separator 30 through the bridge section 80 (see FIG. 3). Then, the oxygen-containing gas flows along the oxygen-containing gas flow field 48 in the direction indicated by the arrow B, and the oxygen-containing gas is supplied to the cathode 44 of the membrane electrode assembly 28a.

In the meanwhile, the fuel gas flows from the fuel gas supply passage 38a into the fuel gas flow field 58 of the second metal separator 32 through the bridge section 90. The fuel gas flows along the fuel gas flow field 58 in the direction indicated by the arrow B, and the fuel gas is supplied to the anode 42 of the membrane electrode assembly 28a.

Thus, in each of the membrane electrode assemblies 28a, the oxygen-containing gas supplied to the cathode 44 and the fuel gas supplied to the anode 42 are partially consumed in electrochemical reactions in the first electrode catalyst layer 44a and the second electrode catalyst layer 42a to generate electricity.

Then, after the oxygen-containing gas supplied to the cathode 44 is partially consumed at the cathode 44, the oxygen-containing gas flows from the oxygen-containing gas flow field 48 through the bridge section 82 to the oxygen-containing gas discharge passage 34b, and the oxygen-containing gas is discharged along the oxygen-containing gas discharge passage 34b in the direction indicated by the arrow A. Likewise, after the fuel gas supplied to the anode 42 is partially consumed at the anode 42, the fuel gas flows from the fuel gas flow field 58 through the bridge section 92 to the fuel gas discharge passage 38b, and the fuel gas is discharged along the fuel gas discharge passage 38b in the direction indicated by the arrow A.

Further, the coolant supplied to the coolant supply passage 36a flows into the coolant flow field 66 between the first metal separator 30 and the second metal separator 32, and then, the coolant flows in the direction indicated by the arrow B. After the coolant cools the membrane electrode assembly 28a, the coolant is discharged from the coolant discharge passage 36b.

In this case, the power generation cell 12 according to the embodiment of the present invention offers the following advantages.

Hereinafter, while the advantages of the embodiment of the present invention will be described in connection with the bead seals in two lines made up of the passage bead 53a provided around the oxygen-containing gas supply passage 34a and the outer bead 54 formed in the first metal separator 30 as a representative example, the same advantages are obtained also in the bead seals in two lines made up of the other passage beads 53 and the outer bead 54 of the first metal separator 30, and the passage beads 63 and the outer bead 64 of the second metal separator 32.

The bead seals provided between the separator outer end 30e and the reactant gas passages (e.g., oxygen-containing gas supply passage 34a, etc.) tend to have low rigidity. In the first metal separator 30, the bead seals (passage bead 53a and outer bead 54) in two lines are provided between the separator outer end 30e and the portion of the reactant gas passage (oxygen-containing gas supply passage 34a, etc.) adjacent to the separator outer end 30e, and one of the bead seals has a wavy shape and the other of the bead seals has a straight shape as viewed in the separator thickness direction. Therefore, in comparison with the structure where both of the bead seals in two lines have a straight shape, improvement in the rigidity of the first bead structure 52 adjacent to the separator outer end 30e is achieved.

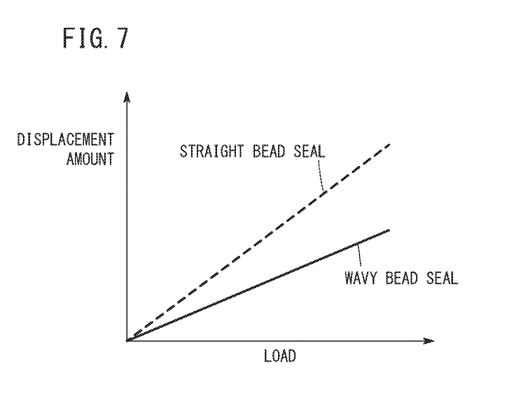

That is, in comparison with the straight bead seal, the rigidity of the wavy bead seal against the load in the separator thickness direction (stacking direction) is high. Therefore, as shown in FIG. 7, in comparison with the straight bead seal, the displacement amount (deformation amount) relative to the load is small. Therefore, in the first metal separator 30 shown in FIG. 4, the bead seals in two lines provided between the separator outer end 30e and the reactant gas passages (oxygen-containing gas supply passage 34a, etc.) include the wavy bead seal (passage bead 53a). Thus, the amount of deformation caused by application of the load in the stacking direction is suppressed. Thus, since the relative decrease in the seal surface pressure adjacent to the separator outer end 30e is suppressed, it is possible to suppress variation in the seal surface pressure.

The wavy bead seal (passage bead 53a) includes at least one recess 55 facing the straight bead seal (outer bead 54) between the separator outer end 30e and the reactant gas passage (oxygen-containing gas supply passage 34a, etc.), as viewed in the separator thickness direction. In the structure, it is possible to produce one of the bead seals in two lines to have a wavy shape easily while maintaining at least the predetermined distance between the bead seals.

Among the bead seals in two lines, between the separator outer end 30e and the reactant gas passage (oxygen-containing gas supply passage 34a, etc.), the bead seal (passage bead 53a) adjacent to the reactant gas passage has a wavy shape. The available space adjacent to the separator outer end 30e is limited significantly, and it is not easy to provide the bead seal having a wavy shape adjacent to the separator outer end 30e. In contrast, the available space adjacent to the reactant gas passage is not limited significantly, and in the structure, it is possible to provide the bead seal having a wavy shape adjacent to the reactant gas passage easily.

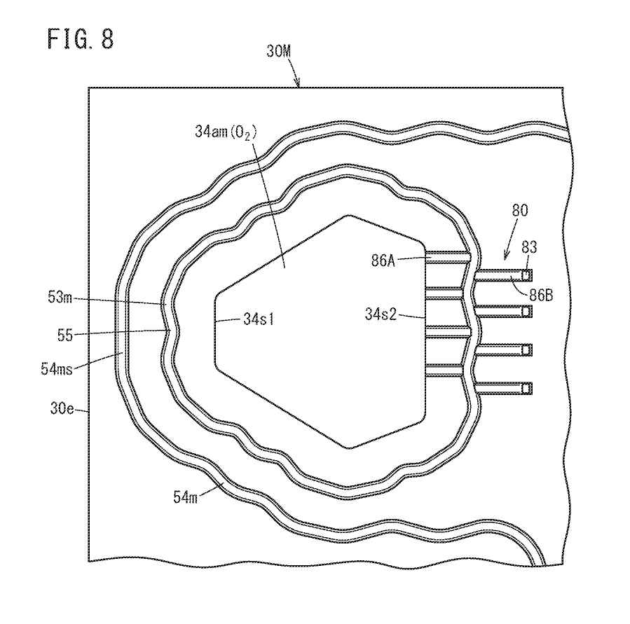

In a first metal separator 30M according to a modified embodiment shown in FIG. 8, the reactant gas passage (e.g., oxygen-containing gas supply passage 34am) has a hexagonal shape. In FIG. 8, the oxygen-containing gas supply passage 34am has a hexagonal shape where a side 34s1 adjacent to the separator outer end 30e (short side of the rectangular first metal separator 30M) is shorter than a side 34s2 adjacent to the oxygen-containing gas flow field 48 (see FIG. 3). The side 34s1 is in parallel with the separator outer end 30e which is the short side of the first metal separator 30M.

One of the bead seals (a passage bead 53m and an outer bead 54m) in two lines provided between the separator outer end 30e and the oxygen-containing gas supply passage 34am has a wavy shape, and the other of the bead seals includes a straight portion. Specifically, the passage bead 53m has a wavy shape between the separator outer end 30e and the oxygen-containing gas supply passage 34am, and a portion of the outer bead 54m facing the separator outer end 30e has a straight shape. That is, the outer bead 54m includes a straight portion 54ms between the separator outer end 30e and the oxygen-containing gas supply passage 34am. The straight portion 54ms extends in parallel with the separator outer end 30e which is the short side of the first metal separator 30M.

The wavy passage bead 53m includes at least one recess 55 between the separator outer end 30e and the oxygen-containing gas supply passage 34am, as viewed in the separator thickness direction. The recess 55 faces the straight portion 54ms of the outer bead 54m. In FIG. 8, though only one recess 55 facing the straight portion 54ms is provided, a plurality of recesses 55 facing a straight portion 54s may be provided. Instead of the at least one recess 55, at least one protrusion may be provided.

In contrast with the above structure, the passage bead 53m may have a straight shape, and the outer bead 54m may have a wavy shape, between the separator outer end 30e and the oxygen-containing gas supply passage 34am.

It should be noted that the oxygen-containing gas discharge passage, the fuel gas supply passage, and the fuel gas discharge passage are provided in the first metal separator 30M. These fluid passages also may have a hexagonal shape as in the case of the oxygen-containing gas supply passage 34am. In this case, it is preferable that the passage beads 53m around the fluid passages and the outer bead 54m may be formed in the same manner as the passage bead 53m around the oxygen-containing gas supply passage 34am and the outer bead 54m. The second metal separator may adopt the same structure as the first metal separator 30M.

The bead structure between the reactant gas passage and the separator outer end is not limited to the bead seals in two lines, as long as the bead seals are arranged in at least two lines.

The present invention is not limited to the above described embodiments. Various modifications may be made without departing from the gist of the present invention.

What is claimed is:

1. A fuel cell metal separator including a reactant gas flow field for allowing a reactant gas to flow along an electrode surface, a reactant gas passage connected to the reactant gas flow field, and bead structure configured to prevent leakage of the reactant gas, the reactant gas passage extending through the fuel cell metal separator in a separator thickness direction, the bead structure protruding in the separator thickness direction,
wherein the bead structure comprises bead seals in two lines between a separator outer end forming one side of the fuel cell metal separator and a portion of the reactant gas passage adjacent to the separator outer end; and
one of the bead seals in two lines has a wavy shape, and another of the bead seals in two lines has a straight shape, as viewed in the separator thickness direction.

2. The fuel cell metal separator according to claim 1, wherein the wavy bead seal includes at least one recess facing the straight bead seal, as viewed in the separator thickness direction.

3. The fuel cell metal separator according to claim 1, wherein, among the bead seals in two lines, the bead seal adjacent to the reactant gas passage has a wavy shape.

4. The fuel cell metal separator according to claim 1, wherein the wavy bead seal is formed around the reactant gas passage; and
the straight bead seal is formed around the reactant gas flow field, and extends between a plurality of the reactant gas passages.

5. The fuel cell metal separator according to claim 1, wherein the reactant gas passage is configured to have a shape where a side of the reactant gas passage adjacent to the separator outer end is shorter than a side of the reactant gas passage adjacent to the reactant gas supply flow field.

6. The fuel cell metal separator according to claim 1, wherein the wavy bead seal is part of a passage bead around the reactant gas passage; and
the straight bead seal is part of an outer bead seal provided around the reactant gas flow field and the reactant gas passage.

7. The fuel cell separator according to claim 6, wherein the outer bead includes a wavy portion as viewed in the separator thickness direction.

8. The fuel cell metal separator according to claim 1, wherein a welding line extending along the bead seals in two lines is provided between the bead seals in two lines.

9. A power generation cell comprising:
a membrane electrode assembly; and
fuel cell metal separators provided on both sides of the membrane electrode assembly;
the fuel cell metal separator including a reactant gas flow field for allowing a reactant gas to flow along an electrode surface, a reactant gas passage connected to the reactant gas flow field, and bead structure configured to prevent leakage of the reactant gas, the reactant gas passage extending through the fuel cell metal separator in a separator thickness direction, the bead structure protruding in the separator thickness direction,
wherein the bead structure comprises bead seals in two lines between a separator outer end forming one side of the fuel cell metal separator and a portion of the reactant gas passage adjacent to the separator outer end; and
one of the bead seals in two lines has a wavy shape, and another of the bead seals in two lines has a straight shape, as viewed in the separator thickness direction.
